(19) United States
(12) Patent Application Publication
(10) Pub. No.: US 2026/0179974 A1
(43) Pub. Date: Jun. 25, 2026

(54) GAS DIFFUSION LAYER AND METHOD FOR MANUFACTURING SAME, COMPOSITE POWDER FOR GAS DIFFUSION LAYER, MEMBRANE ELECTRODE ASSEMBLY, AND FUEL CELL

(71) Applicant: Panasonic Intellectual Property Management Co., Ltd., Osaka (JP)

(72) Inventors: Tsutomu KAWASHIMA, Nara (JP); Takeshi KOIWASAKI, Osaka (JP); Hiroki MARUYAMA, Osaka (JP)

(21) Appl. No.: 19/545,479

(22) Filed: Feb. 20, 2026

Related U.S. Application Data
(63) Continuation of application No. PCT/JP2024/036486, filed on Oct. 11, 2024.

(30) Foreign Application Priority Data
Oct. 13, 2023 (JP) 2023-177735

(51) Int. Cl. H01M 8/0243; H01M 8/1004

(52) U.S. Cl. CPC H01M 8/0243; H01M 8/1004

(57) ABSTRACT

A gas diffusion layer composed of a sheet of composite powder, the composite powder includes: conductive particles; conductive fibers; and a polymer resin, wherein a grain boundary of the composite powder is present on a surface or a cross section of the gas diffusion layer.

### CROSS REFERENCE TO RELATED APPLICATION

This application claims priorities of Japanese Patent Application No. 2023-177735 filed on Oct. 13, 2023 and PCT Application No. PCT/JP2024/036486 filed on Oct. 11, 2024, the contents of which are incorporated herein by reference.

### BACKGROUND OF THE INVENTION

### 1. Field of the Invention

The present disclosure relates to a gas diffusion layer, a method for manufacturing the same, a composite powder for a gas diffusion layer, a membrane electrode assembly, and a fuel cell.

### 2. Description of the Related Art

The gas diffusion layer has gas permeability and gas diffusibility, and is used, for example, in a fuel cell. In a polymer electrolyte fuel cell as an example of a fuel cell, one surface of a polymer electrolyte membrane having hydrogen ion conductivity is exposed to a fuel gas such as hydrogen, and the other surface is exposed to oxygen, and water is synthesized by a chemical reaction through the electrolyte membrane, thereby electrically extracting reaction energy generated at that time.

A unit cell of a polymer electrolyte fuel cell includes a membrane electrode assembly (hereinafter, referred to as MEA) and a pair of conductive separators disposed on both surfaces of the MEA. The MEA includes a polymer electrolyte membrane having hydrogen ion conductivity and a pair of electrode layers sandwiching the electrolyte membrane. The pair of electrode layers includes a catalyst layer which is formed on both surfaces of the polymer electrolyte membrane and contains a carbon powder carrying a platinum group catalyst as a main component, and a gas diffusion layer which is formed on the catalyst layer and has a current collecting action, gas permeability, and water repellency.

The gas diffusion layer in the MEA uniformly supplies the gas supplied from the separator to the catalyst layer. The gas diffusion layer also functions as a conductive path of electrons between the catalyst layer and the separator. Furthermore, the gas diffusion layer is required to have high water repellency so that excess moisture generated by the battery reaction in the catalyst layer is quickly removed and discharged out of the system from the MEA, and pores of the gas diffusion layer are not blocked by generated water.

Therefore, a gas diffusion layer in which an MPL (microporous layer) for managing produced water is formed on porous carbon paper or carbon felt using carbon fiber as a base material is generally used. The carbon paper or the carbon felt is subjected to a water-repellent treatment by being impregnated with a resin having high water repellency. Further, the MPL is composed of conductive particles such as carbon black and a resin having high water repellency, and plays a role of quickly discharging excess moisture generated in the catalyst layer from the MEA to the outside of the system and preventing scattering of moisture more than necessary.

For example, Japanese Patent Application Laid-open No. 2016-195060 A as Patent Document 1 discloses a gas diffusion layer in which a coating layer in a granular shape having an average particle diameter of 1 to 25 μm, a so-called MPL, is formed on at least one surface of a porous substrate.

In the gas diffusion layer described in Patent Document 1, by providing irregularities on the MPL (coating layer) on the surface of the carbon substrate, adhesiveness with the catalyst layer is improved, and liquid water during power generation is efficiently discharged. However, in a high current density region where a large amount of generated water is generated during power generation, water tends to be retained in pores in the carbon fiber base material, and gas diffusibility may be inhibited. In addition, during power generation under low humidity conditions, the MPL (coating layer) cannot sufficiently retain generated water in the MEA, the proton resistance increases, and the battery performance may deteriorate.

### SUMMARY

The present disclosure is intended to solve the above-mentioned problems, and one non-limiting and exemplary embodiments provides a gas diffusion layer that has sufficient gas permeability in a high current density region, has excellent discharge performance of excess moisture, and can retain water inside the MEA even at low humidification.

In one general aspect, the techniques disclosed here feature: a gas diffusion layer composed of a sheet of composite powder, the composite powder containing:
conductive particles;
conductive fibers; and
a polymer resin,
wherein a grain boundary of the composite powder is present on a surface or a cross section of the gas diffusion layer.

In another general aspect, the techniques disclosed here feature: a membrane electrode assembly comprising:
the gas diffusion layer according to claim 1;
a pair of electrodes; and
an electrolyte membrane.

In another general aspect, the techniques disclosed here feature: a fuel cell comprising:
the membrane electrode assembly according to claim 15; and
a current collecting plate.

In another general aspect, the techniques disclosed here feature: a composite powder for a gas diffusion layer, comprising:
conductive particles;
conductive fibers; and
a polymer resin,
wherein an average particle diameter D50 of the composite powder is 30 μm or more and 300 μm or less, and
in the composite powder, pores having a peak in a range of a pore radius of 0.1 μm or more and 0.3 μm or less are present in a Log differential pore volume graph measured by a mercury intrusion method.

In another general aspect, the techniques disclosed here feature: a method for manufacturing a gas diffusion layer, the method comprising:
stirring and kneading conductive particles, conductive fibers, and a polymer resin with a dispersion solvent to obtain a kneaded product of the conductive particles, the conductive fibers, and the polymer resin;
firing the kneaded product at a temperature equal to or higher than a decomposition temperature of the dispersion solvent to remove the dispersion solvent to obtain a solid;
pulverizing the solid to obtain a composite powder containing the conductive particles, the conductive fibers, and the polymer resin; and
rolling the composite powder with a roll to form a sheet to obtain a gas diffusion layer containing a sheet.

The gas diffusion layer according to the present disclosure can provide a fuel cell having sufficient gas permeability and water dischargeability while keeping the inside of a membrane electrode assembly (MEA) using the gas diffusion layer in a water-containing state.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is a schematic perspective view showing a configuration of a polymer electrolyte fuel cell stack according to a first embodiment of the present disclosure;

FIG. 2 is a schematic cross-sectional view showing a cross-sectional structure of the polymer electrolyte fuel cell according to the first embodiment of the present disclosure;

FIG. 3A is a schematic surface view showing a surface state of a gas diffusion layer according to the first embodiment of the present disclosure;

FIG. 3B is a surface SEM photograph of the gas diffusion layer according to the first embodiment of the present disclosure;

FIG. 3C is a SEM photograph obtained by binarizing a surface SEM photograph of the gas diffusion layer according to the first embodiment of the present disclosure and showing a grain boundary region as white pixels;

FIG. 3D is a 3D image of a surface of the gas diffusion layer according to the first embodiment of the present disclosure;

FIG. 3E-A is an image in which only a grain boundary region equal to or less than a height direction threshold is extracted as a white pixel in the 3D image of FIG. 3D, and FIG. 3E-B is a diagram showing a frequency distribution in the height direction in the 3D image of FIG. 3D;

FIG. 4 is a diagram showing a pore distribution of the gas diffusion layer according to the first embodiment of the present disclosure;

FIG. 5 is a schematic view showing a composite powder for a gas diffusion layer according to the first embodiment of the present disclosure;

FIG. 6 is a diagram showing a pore distribution of the composite powder for a gas diffusion layer according to the first embodiment of the present disclosure;

FIG. 7 is a flowchart showing a method for manufacturing the gas diffusion layer according to the first embodiment of the present disclosure;

FIG. 8 is a flowchart showing a method for manufacturing a gas diffusion layer according to a second embodiment of the present disclosure;

FIG. 9 is a flowchart showing a method for manufacturing a gas diffusion layer according to a third embodiment of the present disclosure;

FIG. 10 is a diagram showing a pore distribution of a composite powder for a gas diffusion layer according to the first, second, third embodiments of the present disclosure;

FIG. 11 is a schematic view showing a configuration of an apparatus for manufacturing a gas diffusion layer according to the third embodiment of the present disclosure;

FIG. 12 is a schematic view showing a configuration of an apparatus for manufacturing a gas diffusion layer according to a first modified embodiment;

FIG. 13 is a schematic view showing a configuration of an apparatus for manufacturing a gas diffusion layer according to a second modified embodiment;

FIG. 14 is a schematic view showing a configuration of an apparatus for manufacturing a gas diffusion layer according to a third modified embodiment;

FIG. 15 is a schematic view showing a configuration of an apparatus for manufacturing a gas diffusion layer according to a fourth modified embodiment;

FIG. 16 is a schematic view showing a configuration of an apparatus for manufacturing a gas diffusion layer according to a fifth modified embodiment; and

FIGS. 17A, 17B, and 17C are Table 1-A, 1-B, and 1-C showing a raw material composition, a composite powder for a gas diffusion layer, characteristics of a gas diffusion layer, and the like in first to sixth examples and first and second comparative examples.

### DETAILED DESCRIPTION

A gas diffusion layer composed of a sheet of composite powder according to a first aspect, the composite powder containing:
conductive particles;
conductive fibers; and
a polymer resin,
wherein a grain boundary of the composite powder is present on a surface or a cross section of the gas diffusion layer.

The gas diffusion layer according to a second aspect in addition to the first aspect, in a surface or a cross section of the gas diffusion layer, an area of a grain boundary of the composite powder included in the surface or the cross section may be calculated by binarizing an SEM image, and the area of the grain boundary of the composite powder may be 5% or more with respect to an area of the surface or the cross section in the SEM image.

The gas diffusion layer according to a third aspect, in addition to the first or second aspect, a maximum height Sz may be calculated from a 3D image in a surface or a cross section of the gas diffusion layer, and an area of a grain boundary of the composite powder included in the surface or the cross section may be defined as an area from a lowest point of the 3D image to a height that is 40% of Sz, and the area of the grain boundary of the composite powder may be 1% or more and 30% or less with respect to an area of the surface or the cross section in the 3D image.

The gas diffusion layer according to a fourth aspect, in addition to any one of the first to third aspects, the composite powder may have a particle diameter D50 of 30 μm or more and 300 μm or less.

The gas diffusion layer according to a fifth aspect, in addition to any one of the first to fourth aspects, an arithmetic average height Sa of a surface of the gas diffusion layer may be 3 μm or less.

The gas diffusion layer according to a sixth aspect, in addition to any one of the first to fifth aspects, a skewness Ssk of a surface of the gas diffusion layer may be a negative value, and kurtosis Sku of the surface is 5 or less.

The gas diffusion layer according to a seventh aspect, in addition to any one of the first to sixth aspects, a maximum valley depth Sv of a surface of the gas diffusion layer may be 15 μm or less, and a maximum height Sz of the surface may be 40 μm or less.

The gas diffusion layer according to an eighth aspect, in addition to any one of the first to seventh aspects, a level difference Sk of a core portion may be 13 μm or less, a protruding crest portion height Spk may be 5 μm or less, and a protruding valley portion depth Svk may be 4 μm or less, the level difference Sk, the protruding crest portion height Spk, and the protruding valley portion depth Svk being calculated using a load curve of a surface of the gas diffusion layer.

The gas diffusion layer according to a ninth aspect, in addition to any one of the first to eighth aspects, a void volume Vvv of a valley portion may be 0.5 μm³/μm² or less, a void volume Vvc of a core portion may be 7 μm³/μm² or less, a substantial volume Vmp of a crest portion may be 0.3 μm³/μm² or less, and a substantial volume Vmc of the core portion may be 5.0 μm³/μm² or less, the void volume Vvv, the void volume Vvc, the substantial volume Vmp, and the substantial volume Vmc being calculated using a load curve of a surface of the gas diffusion layer.

The gas diffusion layer according to a tenth aspect, in addition to any one of the first to ninth aspects, the gas diffusion layer has, inside the sheet of the gas diffusion layer,
pores having a peak in a range of a pore radius of 0.1 μm or more and 0.3 μm or less and
a pore volume of pores with a pore radius of 0.055 μm or more and 0.4 μm or less of 0.80 mL/g or less in a Log differential pore volume distribution graph measured by a mercury intrusion method.

The gas diffusion layer according to an eleventh aspect, in addition to any one of the first to tenth aspects, the gas diffusion layer may have, inside the sheet of the gas diffusion layer, pores having a peak in a range of a pore radius of 0.1 μm or more and 0.3 μm or less, a pore volume of pores with a pore radius of 0.055 μm or more and 0.4 μm or less being 0.80 mL/g or less, and a pore volume of pores with a pore radius of 0.4 μm or more and 10 μm or less being 0.10 mL/g or more, in a Log differential pore volume graph measured by a mercury intrusion method.

The gas diffusion layer according to a twelfth aspect, in addition to any one of the first to eleventh aspects, an orientation degree of the conductive fibers is 30% or more and 70% or less, and an orientation degree of the polymer resin is 5% or more and 70% or less in orientation evaluation by fine portion X-ray diffraction measurement.

The gas diffusion layer according to a thirteenth aspect, in addition to any one of the first to twelfth aspects, the composite powder may include:
the conductive particles in an amount of 5 wt % or more and less than 35 wt %;
the conductive fibers in an amount of 35 wt % or more and 80 wt % or less; and
the polymer resin in an amount of 10 wt % or more and 40 wt % or less.

The gas diffusion layer according to a fourteenth aspect, in addition to any one of the first to thirteenth aspects, the polymer resin may contain polytetrafluoroethylene.

A membrane electrode assembly according to a fifteenth aspect, includes:
the gas diffusion layer according to any one of the first to fourteenth aspect;
a pair of electrodes; and
an electrolyte membrane.

A fuel cell according to a sixteenth aspect, includes:
the membrane electrode assembly according to the fifteenth aspect; and
a current collecting plate.

A composite powder for a gas diffusion layer according to a seventeenth aspect, includes:
conductive particles;
conductive fibers; and
a polymer resin,
wherein an average particle diameter D50 of the composite powder is 30 μm or more and 300 μm or less, and
in the composite powder, pores having a peak in a range of a pore radius of 0.1 μm or more and 0.3 μm or less are present in a Log differential pore volume graph measured by a mercury intrusion method

The composite powder for a gas diffusion layer according to an eighteenth aspect, in addition to the seventeenth aspects, the composite powder for a gas diffusion layer may have, inside the composite powder for a gas diffusion layer, pores with a pore radius of 0.055 μm or more and 0.4 μm or less having a pore volume of 0.90 mL/g or less in a Log differential pore volume graph measured by a mercury intrusion method.

The composite powder for a gas diffusion layer according to a nineteenth aspect, in addition to the seventeenth or eighteenth aspect, may include:
the conductive particles in an amount of 5 wt % or more and less than 35 wt %;
the conductive fibers in an amount of 35 wt % or more and 80 wt % or less; and
the polymer resin in an amount of 10 wt % or more and 40 wt % or less.

The composite powder for a gas diffusion layer according to a twentieth aspect, in addition to any one of the seventeenth to nineteenth aspects, the polymer resin may contain polytetrafluoroethylene.

A method for manufacturing a gas diffusion layer according to a twenty-first aspect, the method includes:
stirring and kneading conductive particles, conductive fibers, and a polymer resin with a dispersion solvent to obtain a kneaded product of the conductive particles, the conductive fibers, and the polymer resin;
firing the kneaded product at a temperature equal to or higher than a decomposition temperature of the dispersion solvent to remove the dispersion solvent to obtain a solid;
pulverizing the solid to obtain a composite powder containing the conductive particles, the conductive fibers, and the polymer resin; and
rolling the composite powder with a roll to form a sheet to obtain a gas diffusion layer containing a sheet.

The method for manufacturing a gas diffusion layer according to a twenty-second aspect, in addition to twenty-first aspect, in the course of removing the dispersion solvent of the kneaded product, firing may be performed at a temperature and for a time at which a residue of the dispersion solvent becomes 1 wt % or less.

The method for manufacturing a gas diffusion layer according to a twenty-third aspect, in addition to twenty-first or twenty second aspect, in the course of pulverizing the solid, the solid may be pulverized into a composite powder having an average particle diameter D50 of 30 μm or more and 300 μm or less.

The method for manufacturing a gas diffusion layer according to a twenty-fourth aspect, in addition to any one of twenty-first to twenty-third aspects, further may include classifying the powder into a composite powder having an average particle diameter D50 of 30 μm or more and 300 μm or less after pulverizing the solid.

The method for manufacturing a gas diffusion layer according to a twenty-fifth aspect, in addition to any one of twenty-first to twenty-fourth aspects, further may include re-rolling the sheet to adjust a film thickness and porosity of the sheet after rolling the composite powder with a roll to form a sheet.

The method for manufacturing a gas diffusion layer according to a twenty-sixth aspect, in addition to any one of twenty-first to twenty-fifth aspects, further may include heating the sheet after rolling the composite powder with a roll to form a sheet.

The method for manufacturing a gas diffusion layer according to twenty-seventh aspect, in addition to any one of twenty-first to twenty-sixth aspects, further may include impregnating the sheet with a solution and heating the sheet after rolling the composite powder with a roll to form a sheet.

The method for manufacturing a gas diffusion layer according to a twenty-eighth aspect, in addition to any one of twenty-first to twenty-seventh aspects, further may include heating the sheet while controlling expansion in a film thickness direction after rolling the composite powder with a roll to form a sheet.

The method for manufacturing a gas diffusion layer according to a twenty-nineth aspect, in addition to any one of twenty-first to twenty-eighth aspects, further may include intermittently heating the sheet twice or more after rolling the composite powder with a roll to form a sheet.

The method for manufacturing a gas diffusion layer according to a thirtieth aspect, in addition to any one of twenty-first to twenty-nineth aspects, further may include heating one surface of the sheet while cooling the other surface after rolling the composite powder with a roll to form a sheet.

The method for manufacturing a gas diffusion layer according to a thirty-first aspect, in addition to any one of twenty-first to thirtieth aspects, further may include heating the sheet while rolling the sheet between a heating roll and a cooling roll after rolling the composite powder with a roll to form a sheet.

The method for manufacturing a gas diffusion layer according to a thirty-second aspect, in addition to any one of twenty-sixth aspect, a temperature at which the sheet may be heated is 300° C. or more and 400° C. or less.

The method for manufacturing a gas diffusion layer according to a thirty-third aspect, in addition to any one of twenty-first to thirty-second aspects, further may include re-rolling a sheet between a pair of rolls after rolling the composite powder with rolls to form the sheet.

Hereinafter, a gas diffusion layer, a method for manufacturing the gas diffusion layer, a composite powder for a gas diffusion layer, a membrane electrode assembly, and a fuel cell according to embodiments of the present disclosure will be described with reference to the accompanying drawings.

### First Embodiment

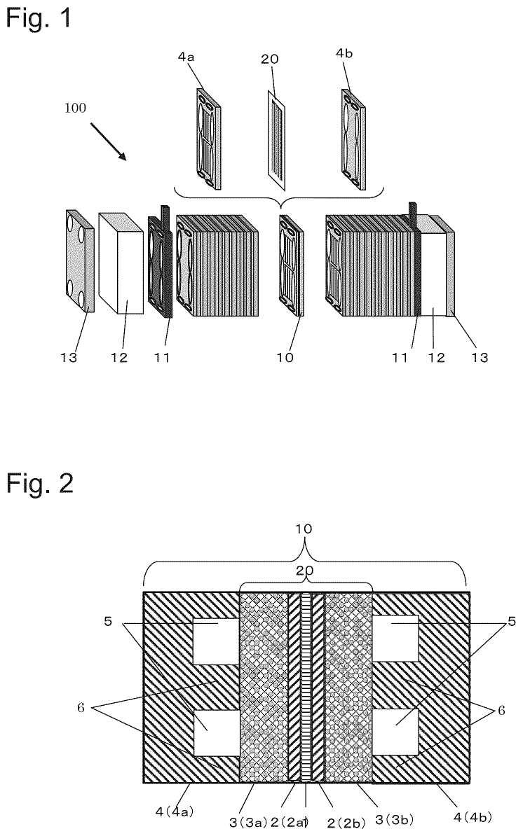

A basic configuration of a fuel cell 100 according to a first embodiment of the present disclosure will be described with reference to FIG. 1. FIG. 1 is a schematic perspective view showing a configuration of the fuel cell (hereinafter, also referred to as a polymer electrolyte fuel cell stack) 100 according to the first embodiment. The present embodiment is not limited to the polymer electrolyte fuel cell, and can be applied to various fuel cells.

### <Fuel Cell>

As shown in FIG. 1, in the fuel cell 100, one or more battery cells 10 as a basic unit are stacked, and compressed and fastened with a predetermined load using current collecting plates 11, insulating plates 12, and end plates 13 disposed on both sides of the stacked battery cells 10.

The current collecting plate 11 is formed of a gas-impermeable conductive material. For example, copper, brass, or the like is used for the current collecting plate 11. The current collecting plate 11 is provided with a current extraction terminal portion (not shown), and a current is extracted from the current extraction terminal portion during power generation.

The insulating plate 12 is formed of an insulating material such as resin. For example, a fluorine-based resin, a PPS resin, or the like is used for the insulating plate 12.

The end plates 13 fasten and hold one or more stacked battery cells 10, the current collecting plates 11, and the insulating plates 12 with a predetermined load by a pressurizing means (not shown). A highly rigid metal material such as steel is used for the end plate 13.

FIG. 2 is a schematic cross-sectional view showing a cross-sectional structure of the battery cell 10. In the battery cell 10, the membrane electrode assembly (hereinafter, also referred to as MEA) 20 is sandwiched between an anode side separator 4a and a cathode side separator 4b. Hereinafter, the anode side separator 4a and the cathode side separator 4b are collectively referred to as a separator 4. In a case where a plurality of other components are described together, the same description will be made.

A fluid flow path 5 is formed in the separator 4. A fluid flow path 5 for fuel gas is formed in the anode side separator 4a. A fluid flow path 5 for oxidant gas is formed in the cathode side separator 4b. A carbon-based material and a metal-based material can be used for the separator 4.

The fluid flow path 5 is a groove formed in separator 4. A rib portion 6 is provided around the fluid flow path 5.

### <Membrane Electrode Assembly: MEA>

A membrane electrode assembly (MEA) 20 includes a polymer electrolyte membrane 1, a catalyst layer 2, and a gas diffusion layer 3. An anode catalyst layer 2a and a cathode catalyst layer 2b (combined catalyst layer 2) are formed on both surfaces of the polymer electrolyte membrane 1 that selectively transports hydrogen ions, and an anode-side gas diffusion layer 3a and a cathode gas diffusion layer 3b (combined gas diffusion layer 3) are disposed outside the anode catalyst layer 2a and the cathode catalyst layer 2b, respectively.

For the polymer electrolyte membrane 1, for example, a perfluorocarbon sulfonic acid polymer is used, but it is not particularly limited as long as it has proton conductivity.

As the catalyst layer 2, a layer containing a carbon material carrying catalyst particles such as platinum and a polymer electrolyte can be used.

### <Gas Diffusion Layer 3>

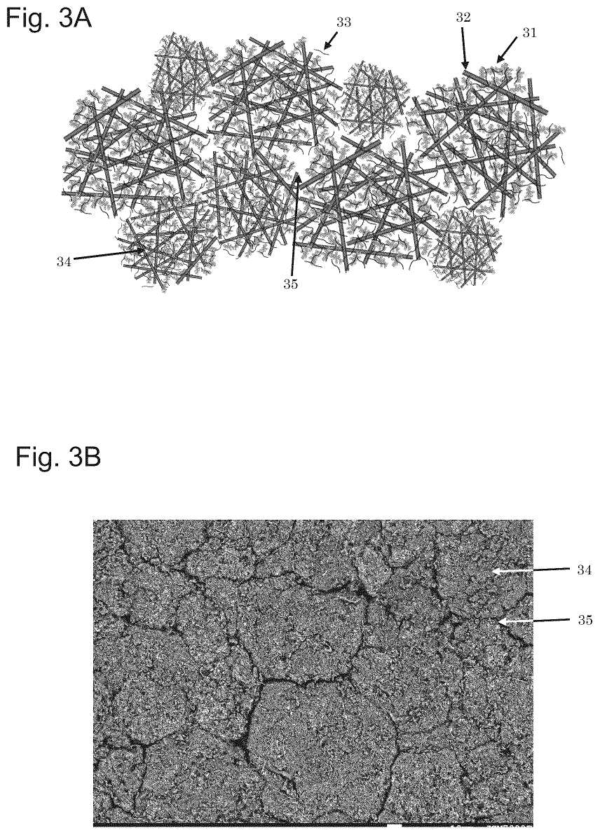

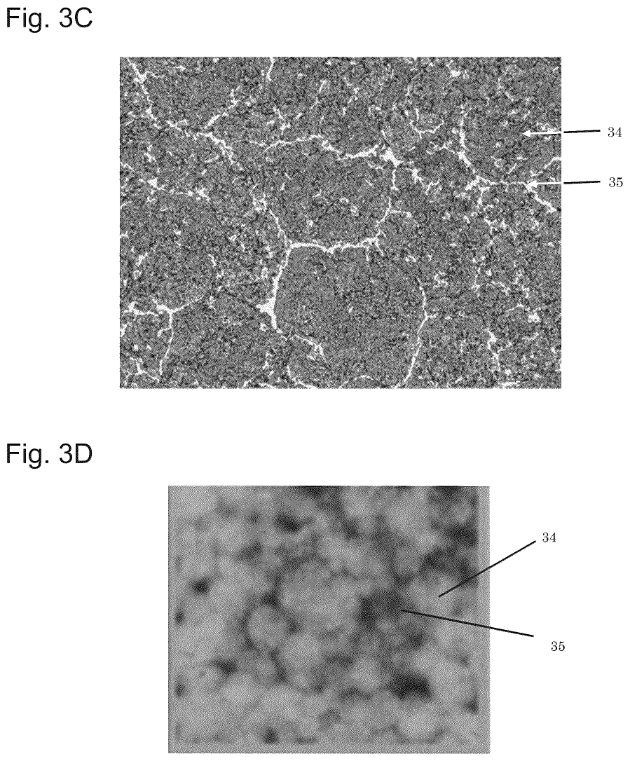

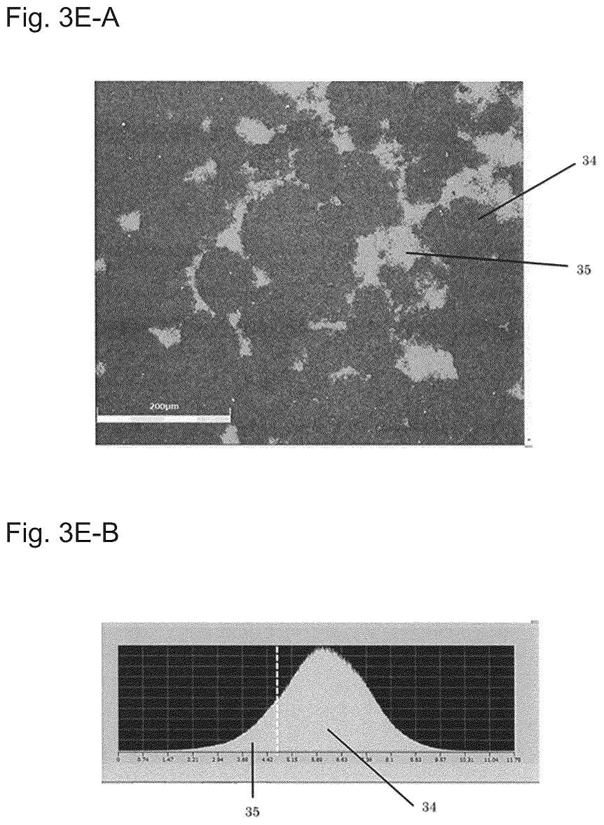

Next, a configuration of the gas diffusion layer 3 according to the exemplary embodiment of the present disclosure will be described in detail with reference to FIGS. 3A, 3B, and 3C.

FIG. 3A is a schematic surface view showing a surface state of the gas diffusion layer 3. FIG. 3B is a surface SEM photograph of the gas diffusion layer 3. FIG. 3C is a SEM photograph showing a grain boundary area obtained by binarizing a surface SEM photograph of the gas diffusion layer 3 and using a grain boundary as a white pixel.

The gas diffusion layer 3 contains conductive particles 31, conductive fibers 32, and a polymer resin 33. The gas diffusion layer 3 is preferably a free-standing film supported by the conductive particles 31, the conductive fibers 32, and the polymer resin 33. The free-standing film means a film having a self-supporting structure.

The gas diffusion layer 3 of the present disclosure will be described in detail. As shown in FIG. 3A, in the gas diffusion layer 3, grains (particles) included in the composite powder 34 containing the conductive particles 31, the conductive fibers 32, and the polymer resin 33 are integrated by bonding of the polymer resin 33 present on the outer periphery of each grain (particle) included in the composite powder. Accordingly, in the gas diffusion layer 3, a grain boundary 35 exists between grains (particles) of the composite powder 34. The grain boundary 35 is defined as a grain boundary 35 including an interface where the grains included in the composite powder 34 are bonded to each other by the polymer resin 33 and a portion where the grains included in the composite powder 34 are not bonded to each other to form a minute gap between the grains.

In the gas diffusion layer 3 according to the first embodiment of the present disclosure, the grain boundary 35 formed by rolling the composite powder 34 containing the conductive particles 31, the conductive fibers 32, and the polymer resin 33 exists on a surface of the gas diffusion layer 3. Then, an area ratio of an area of the grain boundary 35 included in the surface or cross section of the gas diffusion layer 3 to a predetermined area of the surface or cross section of the gas diffusion layer 3 is, for example, 5% or more.

The surface of the gas diffusion layer 3 means both surfaces in contact with the catalyst layer and the separator.

The role of the grain boundary 35 between the grains included in the composite powder 34 constituting the gas diffusion layer 3 and the composite powder 34 will now be described. The conductive particles 31 and the conductive fibers 32 are dispersed in the composite powder 34, and bonded to each other by the polymer resin 33. In the composite powder, there are pores which are gaps between the conductive particles 31 and between the conductive fibers 32 and having a pore radius of submicron (0.1 to 0.3 μm). The submicron pores function as a diffusion path of gas and water vapor without allowing water to pass therethrough.

On the other hand, the grain boundary 35 of the composite powder 34 is constituted by an interface bonded by the polymer resin 33 and a minute gap, and a gap having a width of several microns also exists as a size of the minute gap. Therefore, the grain boundary 35 has a function of discharging condensed water generated in a gap between the interface between the catalyst layer 2 and the gas diffusion layer 3 or condensed water generated by condensation of water vapor in submicron pores of the composite powder 34 inside the gas diffusion layer 3 to the outside by a capillary phenomenon.

Therefore, when the grain boundary area ratio of the gas diffusion layer 3 is less than 5%, the discharge performance of the condensed water generated at the interface between the catalyst layer 2 and the gas diffusion layer 3 and the inside of the composite powder 34 inside the gas diffusion layer 3 is deteriorated particularly during power generation under high humidity conditions, and the gas diffusibility is inhibited, resulting in deterioration of battery performance.

On the other hand, when the grain boundary area ratio of the gas diffusion layer 3 is 50% or more, there are many interfaces and minute gaps bonded by the polymer resin 33, and the strength as a free-standing film cannot be maintained.

### <Method for Calculating Ratio of Grain Boundary Area by Binarization of SEM Photograph of Gas Diffusion Layer 3>

Here, a method for calculating the grain boundary area ratio on the surface of the gas diffusion layer 3 will be described.

A SEM photograph (FIG. 3B) of the surface or the cross section of the gas diffusion layer 3 is taken, the SEM photograph is binarized to extract only white pixels as grain boundary region from the binarized image of the SEM photograph (FIG. 3C). For example, the grain boundary area ratio can be calculated as a ratio of an area of the grain boundary region extracted to an area of the surface or cross section of the gas diffusion layer 3.

Specifically, the grain boundary area ratio was calculated by the following method.
(1) The surface or cross section of the gas diffusion layer 3 is photographed as a BSE image with a SEM (JSM 7900 F manufactured by JEOL Ltd.) at a magnification of ×400 at an acceleration voltage of 10 kV.
(2) After the BSE image is converted into an 8-bit gray image with binarization software (for example, ImageJ), binarization processing is performed to calculate the area ratio of the grain boundary region.

In the gas diffusion layer 3 according to the first embodiment of the present disclosure, the grain boundaries 35 formed by rolling the composite powder 34 containing the conductive particles 31, the conductive fibers 32, and the polymer resin 33 exist on a surface or a cross section of the gas diffusion layer 3. In the surface or the cross section of the gas diffusion layer, the maximum height Sz is calculated from the 3D image of the surface or the cross section, and the area of the grain boundary of the composite powder included in the surface or the cross section is defined as the area from the lowest point of the 3D image to the height that is 40% of Sz, and the area of the grain boundary of the composite powder is 1% or more and 30% or less with respect to the area of the surface or the cross section. It is noted that the surface of the gas diffusion layer 3 means both surfaces in contact with the catalyst layer and the separator.

The role of the grain boundary 35 between the composite powder 34 constituting the gas diffusion layer 3 and the composite powder 34 is as described above.

If the area of the grain boundary of the composite powder is smaller than 1% of the area of the surface or the cross section, the discharge performance of the condensed water generated at the interface between the catalyst layer 2 and the gas diffusion layer 3 and the inside of the composite powder 34 inside the gas diffusion layer 3 is deteriorated particularly during power generation under high humidity conditions, and the gas diffusibility is hindered to deteriorate the battery performance.

On the other hand, when the area of the grain boundary of the composite powder is 30% or more of the area of the surface or the cross section, there are a large number of interfaces and minute gaps bonded by the polymer resin 33, and the strength as a free-standing film cannot be maintained.

<Method for Calculating Grain Boundary Area Ratio from Height Information of 3D Image of Gas Diffusion Layer 3>

A method for calculating the grain boundary area ratio of the surface of the gas diffusion layer 3 according to another embodiment will be described.

A 3D image (FIG. 3D) of the surface of the gas diffusion layer 3 is taken, only a region having a height value of threshold value or less along height direction is extracted as a grain boundary region in the 3D image (FIG. 3E-A), and for example, the grain boundary area ratio can be calculated as a ratio of the grain boundary area extracted with the grain boundary as a white pixel to the surface area of the gas diffusion layer 3. Specifically, the grain boundary area ratio was calculated by the following method.
(1) A 3D image is acquired with a laser microscope.
(2) The maximum height Sz is calculated from the 3D image subjected to the inclination correction.
(3) As shown in FIG. 3E-B, the area from the lowest point of the 3D image to the height that is 40% of the maximum height Sz is defined as an area of the grain boundary of the composite powder, and the area ratio of the grain boundary to the total area is calculated.

The 3D image of the surface of the gas diffusion layer 3 can be acquired using, for example, a laser microscope (LEXT OLS4000, manufactured by OLYMPUS).

### <Particle Diameter of Powder 34 Constituting Gas Diffusion Layer 3>

The particle diameter D50 of the composite powder 34 containing conductive particles, conductive fibers, and a polymer resin constituting the gas diffusion layer 3 is 30 μm or more and 300 μm or less. The particle diameter D50 is more preferably 50 μm or more and 150 μm or less.

When the particle diameter D50 of the composite powder 34 is smaller than 30 μm, many grain boundaries 35 are present in the gas diffusion layer 3. As described above, the grain boundaries 35 have a function of discharging condensed water, but when there are many grain boundaries 35, diffusion of gas and water vapor through submicron pores inside the powder 34 is inhibited by the grain boundaries 35, and battery performance deteriorates due to deterioration of gas diffusibility.

On the other hand, when the particle diameter D50 of the composite powder 34 is larger than 300 μm, the number of interfaces bonded by the polymer resin at the grain boundaries 35 between the grains included in the composite powder 34 decreases and the gap between the grains included in the composite powder 34 becomes too large, so that the strength of the gas diffusion layer 3 decreases and the gas diffusion layer 3 cannot exist as a free-standing film.

The particle diameter of the composite powder 34 is obtained by calculating the area of the composite powder from the binarized grain boundary and calculating the particle diameter D50 at which the cumulative frequency is 50% from the diameter converted into a perfect circle.

### <Arithmetic Average Height Sa of Surface of the Gas Diffusion Layer 3>

The arithmetic average height Sa of the surface of the gas diffusion layer 3 is 3 μm or less. The arithmetic average height Sa is more preferably 2 μm or less.

When the arithmetic average height Sa of the surface of the gas diffusion layer 3 is larger than 3 μm, a micron-order gap is generated on the contact surface between the catalyst layer and the separator, so that condensed water stagnates in the gap, and battery performance is deteriorated due to deterioration of gas diffusibility.

### <Skewness Ssk and Kurtosis Sku of Surface of Gas Diffusion Layer 3>

The skewness Ssk of the surface of the gas diffusion layer 3 is a negative value, and the kurtosis Sku is 5 or less.

The fact that the skewness Ssk of the surface of the gas diffusion layer 3 is a negative value means that the height distribution is biased to the mountain side. In addition, the fact that the kurtosis Sku is 5 or less means that kurtosis of the surface is relatively close to a crushed shape.

Therefore, the gas diffusion layer 3 according to the present disclosure can increase a contact area of a surface of the catalyst layer or the separator, reduce contact resistance and suppress retention of liquid water in a minute gap at a contact interface, achieve both low resistance and high gas diffusibility, and improve battery performance.

### <Maximum Valley Depth Sv of Surface of Gas Diffusion Layer 3 and Maximum Height Sz of Surface of Gas Diffusion Layer 3>

The maximum valley depth Sv of the surface of the gas diffusion layer 3 is 15 μm or less, and the maximum height Sz of the surface is 40 μm or less.

When the maximum valley depth Sv of the surface of the gas diffusion layer 3 is 15 μm or less and the maximum height Sz of the surface is 40 μm or less, the contact area of the surface of the catalyst layer or the separator can be increased, the contact resistance can be reduced, the retention of liquid water in minute gaps of the contact interface can be suppressed, both low resistance and high gas diffusibility can be achieved, and battery performance can be improved.

### <Level Difference Sk, Protruding Crest Portion Height Spk, and Protruding Valley Portion Depth Svk of Core Portion on Surface of Gas Diffusion Layer 3>

The level difference Sk of the core portion is 13 μm or less, the protruding crest portion height Spk is 5 μm or less, and the protruding valley portion depth Svk is 4 μm or less, which are calculated using the load curve of the surface of the gas diffusion layer 3.

Since the level difference Sk of the core portion is 13 μm or less, the protruding crest portion height Spk is 5 μm or less, and the protruding valley portion depth Svk is 4 μm or less, which are calculated using the load curve of the surface of the gas diffusion layer 3, the contact area of the surface of the catalyst layer or the separator can be increased, the contact resistance can be reduced, the retention of liquid water in minute gaps of the contact interface can be suppressed, low resistance and high gas diffusibility can be achieved, and battery performance can be improved. Furthermore, since the protruding crest portion height Spk is as small as 5 μm or less, mechanical damage to the polymer electrolyte membrane can be reduced at the joint surface with the catalyst layer.

### <Void Volume Vvv of Valley Portion, Void Volume Vvc of Core Portion, Actual Volume Vmp of Crest Portion, and Actual Volume Vmc of Core Portion on Surface of Gas Diffusion Layer 3>

The void volume Vvv of the valley portion is 0.5 μm³/μm² or less, the void volume Vvc of the core portion is 7 μm³/μm² or less, the actual volume Vmp of the crest portion is 0.3 μm³/μm² or less, and the actual volume Vmc of the core portion is 5.0 μm³/μm², which are calculated using the load curve of the surface of the gas diffusion layer 3.

When the void volume Vvv of the valley portion is 0.5 μm³/μm² or less, the void volume Vvc of the core portion is 7 μm³/μm² or less, the actual volume Vmp of the crest portion is 0.3 μm³/μm² or less, and the actual volume Vmc of the core portion is 5.0 μm³/μm², which are calculated using the load curve of the surface of the gas diffusion layer 3, it is possible to increase the contact area of the surface of the catalyst layer or the separator, to reduce contact resistance and suppress retention of liquid water in minute gaps of the contact interface, to achieve both low resistance and high gas diffusibility, and to improve battery performance. Further, since the actual volume Vmp of the crest portion is as small as 0.3 μm³/μm² or less, mechanical damage to the polymer electrolyte membrane at the joint surface with the catalyst layer can be reduced.

The surface shape is calculated in accordance with the terms and definitions described in JIS B0681-2-2018 (corresponding to ISO 25178-2).

### <Pore Diameter and Pore Volume of Gas Diffusion Layer 3>

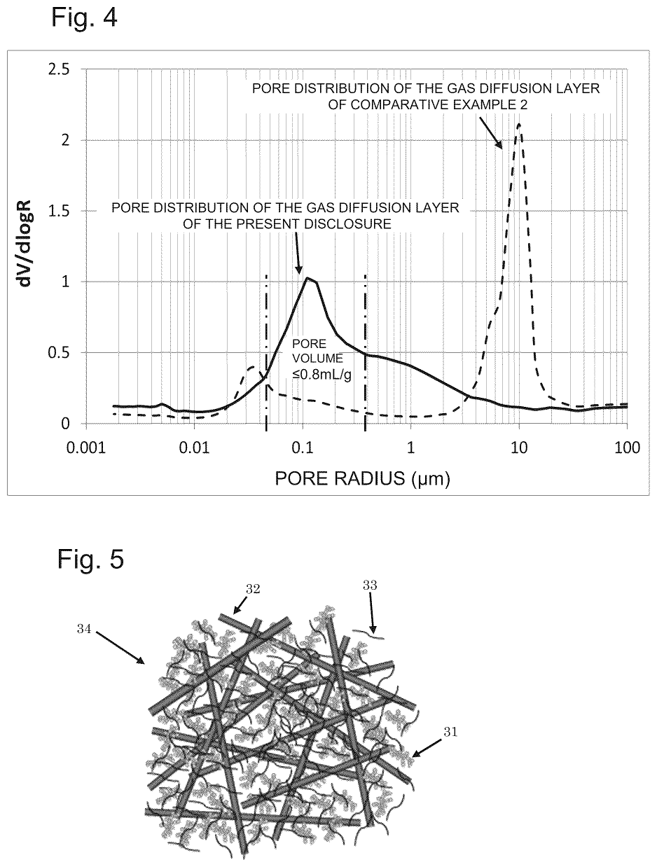

FIG. 4 is a diagram showing a pore distribution of the gas diffusion layer according to the first embodiment.

As shown in FIG. 4, the gas diffusion layer 3 has pores having a peak in a range of a pore radius of 0.1 μm or more and 0.3 μm or less and a pore volume of 0.80 mL/g or less in 0.055 μm or more and 0.4 μm or less in a Log differential pore volume distribution graph measured by a mercury intrusion method.

Here, the pores inside the gas diffusion layer 3 will be described.

The pores inside the gas diffusion layer 3 have the following three functions. First, there is a function of diffusing the fuel gas and the oxidant gas flowing through the gas flow path of the separator into the catalyst 2. Second, there is a function of controlling generated water generated by the reaction to retain the catalyst layer 2 and the polymer electrolyte membrane 1, and quickly discharging excess generated water to the outside through pores. Third, there is a function of sending moisture in the humidified fuel gas and oxidant gas to the catalyst layer 2 and the polymer electrolyte membrane 1 under the condition that the catalyst 2 and the polymer electrolyte membrane 1 cannot be sufficiently retained only with generated water, and securing proton conductivity.

When the gas diffusion layer 3 has pores with a pore radius of 0.1 μm or more and 0.3 μm or less inside, the permeability of water vapor can be sufficiently secured in the pores of this size, and the permeability to condensed water or micro mist is suppressed. Therefore, it is possible to quickly discharge excess moisture as water vapor while maintaining the catalyst layer 2 and the polymer electrolyte membrane 1 in an appropriate water-containing state.

Pores having a pore radius of 0.1 μm or more and 0.3 μm or less are formed by gaps between the conductive fibers 32. Therefore, when the amount of the conductive fibers 32 constituting the gas diffusion layer 3 is larger than that of the conductive particles 31, the peak of the pore radius in the gas diffusion layer 3 can be formed in the range of 0.1 μm or more and 0.3 μm or less.

The gas diffusion layer 3 has pores with a pore radius of 0.055 μm or more and 0.4 μm or less and a pore volume of 0.80 mL/g or less. When the pore volume having a pore radius of 0.055 μm or more and 0.4 μm or less is more than 0.80 mL/g, the discharge amount of water vapor increases, and particularly during operation at low humidification, water retainability of the catalyst layer 2 and the polymer electrolyte membrane 1 decreases, so that proton conductivity decreases, and battery performance deteriorates.

The gas diffusion layer may have, inside the sheet, pores having a peak in a range of a pore radius of 0.1 μm or more and 0.3 μm or less, a pore volume of pores with a pore radius of 0.055 μm or more and 0.4 μm or less being 0.80 mL/g or less, and a pore volume of pores with a pore radius of 0.4 μm or more and 10 μm or less being 0.10 mL/g or more, in a Log differential pore volume graph measured by a mercury intrusion method.

The pores having a pore radius of 0.4 μm or more and 1 μm or less are pores generated by the interface 35 of the composite powder 34, and have a function of discharging condensed water generated in a gap between the interface between the catalyst layer 2 and the gas diffusion layer 3 or condensed water generated by condensation of water vapor in the submicron pores of the composite powder 34 inside the gas diffusion layer 3 to the outside by a capillary phenomenon.

A pore volume in a pore radius of 0.4 μm or more and 10 μm or less is 0.10 mL/g or more. When the pore volume is less than 0.10 mL/g, discharge of condensed water generated in the gas diffusion layer is reduced, and gas diffusibility may be reduced.

The pore size distribution and the pore volume of the gas diffusion layer 3 can be measured by a mercury intrusion method after drying the gas diffusion layer 3 at 120° C. for 4 hours as pretreatment.

### <Orientation Degree of Gas Diffusion Layer 3>

In the orientation evaluation of the gas diffusion layer 3 by fine portion X-ray diffraction measurement, the orientation degree of the conductive fibers 32 is, for example, 30% or more and 70% or less, and the orientation degree of the polymer resin 33 is, for example, 5% or more and 70% or less.

The orientation direction of the conductive fibers 32 and the orientation direction of the polymer resin 33 are directions (MD directions) in which roll pressing is performed during manufacturing the gas diffusion layer 3.

Here, the influence of the orientation degree of the conductive fibers 32 and the orientation degree of the polymer resin 33 on the gas diffusion layer 3 will be described.

The gas diffusion layer 3 is continuously manufactured by roll pressing a composite powder composed of the conductive particles 31, the conductive fibers 32, and the polymer resin 33. By orienting the conductive fibers 32 and the polymer resin 33 in a rolling direction (MD direction) at the time of roll pressing to increase the tensile breaking strength in the orientation direction, breakage of the gas diffusion layer can be suppressed at the time of continuous manufacture by roll pressing.

When the orientation degree of the conductive fibers 32 is less than 30% or the orientation degree of the polymer resin 33 is less than 5%, the tensile breaking strength of the gas diffusion layer 3 in the rolling direction decreases, and the gas diffusion layer 3 is easily broken during continuous manufacture.

On the other hand, when the orientation degree of the conductive fibers 32 is larger than 70% or the orientation degree of the polymer resin 33 is larger than 70%, the tensile breaking strength in the direction (TD direction) orthogonal to the rolling direction decreases, and the gas diffusion layer 3 is likely to be cracked.

For the orientation degree of the conductive fibers 32 and the orientation degree of the polymer resin 33 in the gas diffusion layer 3, peaks of 2θ of the conductive fibers 32 and the polymer resin 33 were identified by a θ-2θ method using, for example, an X-ray diffractometer (RINT-RAPID, manufactured by Rigaku Corporation), and then the degrees of orientation were calculated from in-plane intensity distributions of peaks of 2θ of the conductive fibers 32 and the polymer resin 33 from a diffraction image of a Debye ring of the gas diffusion layer 3 by a permeation method.

### <Types of Conductive Particles 31, Conductive Fibers 32, and Polymer Resin 33>

As the conductive particles 31, for example, a carbon material such as carbon black, graphite, or activated carbon can be used. Among them, it is preferable to use carbon black having high conductivity and a large pore volume. As the carbon black, acetylene black, Ketjen black, furnace black, and Vulcan can be used. Among them, acetylene black having a small impurity amount or ketjen black having a large specific surface area and high conductivity is preferably used. As the conductive particles, fullerenes such as C60 fullerene may be used.

In the size of the conductive particles, for example, D50 is 10 nm or more and 5 μm or less. Furthermore, for example, D50 may be 10 nm or more and 500 nm or less, and may be 10 nm or more and 100 nm or less. When the conductive particles are carbon black, for example, the primary particle diameter may be 10 nm or more and 500 nm or less and 10 nm or more and 100 nm or less, and the size of the aggregate (primary aggregate) may be, for example, 100 nm or more and 500 nm or less. When the conductive particles are graphite or activated carbon, for example, D50 is 1 μm or more and 5 μm or less.

The conductive fibers 32 contribute to improvement of conductivity and improvement of mechanical strength of the gas diffusion layer 3. The material of the conductive fibers 32 is not particularly limited, but for example, carbon fibers such as carbon nanotubes can be used.

The average fiber diameter of the conductive fibers 32 is preferably 50 nm or more and 300 nm or less. When the average fiber diameter of the conductive fibers 32 is 50 nm or more, it is possible to more effectively contribute to improvement of conductivity of the gas diffusion layer 3 and to further enhance mechanical strength of the gas diffusion layer 3. Thus, the gas diffusion layer 3 can have sufficient strength as a free-standing film. When the average fiber diameter of the conductive fibers 32 is 300 nm or less, the diameter does not become too large, so that the pore volume in the porous member 30 can be easily secured sufficiently. Accordingly, the gas diffusibility of the gas diffusion layer 3 can be further enhanced.

The average fiber length of the conductive fibers 32 is preferably 0.5 μm or more and 50 μm or less. When the average fiber length of the conductive fibers 32 is 0.5 μm or more, it is possible to more effectively contribute to improvement of conductivity of the gas diffusion layer 3 and to further enhance mechanical strength of the gas diffusion layer 3. When the average fiber length of the conductive fibers 32 is 50 μm or less, the fibers are not excessively long, so that the polymer resin 33 are crushed without forming lumps during manufacture, and the gas diffusibility of the gas diffusion layer 3 can be further enhanced.

Examples of the polymer resin 33 include PTFE (polytetrafluoroethylene), FEP (tetrafluoroethylene-hexafluoropropylene copolymer), PVDF (polyvinylidene fluoride), ETFE (tetrafluoroethylene-ethylene copolymer), PCTFE (polychlorotrifluoroethylene), and PFA (polyfluoroethylene-perfluoroalkyl vinyl ether copolymer). Among them, PTFE is preferably used as the polymer resin 33 from the viewpoint of heat resistance, water repellency, and chemical resistance. Examples of the raw material form of PTFE include dispersion, powder, and the like. Among them, dispersions are preferable because of excellent dispersibility.

The polymer resin 33 has a function as a binder that binds the conductive particles 31 and the conductive fibers 32 to each other. The polymer resin 33 has water repellency, and therefore also has a role of preventing water from staying in pores inside the gas diffusion layer 3 and gas permeation from being inhibited.

Further, in the gas diffusion layer 3, the conductive particles 31 exist in gaps between the conductive fibers 32, and the conductive fibers 32 and the conductive particles 31 can be favorably bound by the fibrous polymer resin 33, so that the gas diffusion layer 3 can have sufficient strength.

### <Composition of Gas Diffusion Layer 3>

The gas diffusion layer 3 preferably contains 5 wt % or more and less than 35 wt % of the conductive particles 31. That is, the content ratio of the conductive particles 31 is preferably 5 wt % or more and less than 35 wt % with respect to the entire gas diffusion layer 3. When the content ratio of the conductive particles 31 is 5 wt % or more, the amount of the conductive particles 31 filling gaps between the conductive fibers 32 becomes a sufficient amount, so that bulk resistance of the gas diffusion layer 3 is less likely to increase. When the content ratio of the conductive particles 31 is less than 35 wt %, the gaps between the conductive fibers 32 are not excessively reduced, so that water dischargeability and gas diffusibility are further improved.

The gas diffusion layer 3 preferably contains the conductive fibers 32 in an amount of 35 wt % or more and 80 wt % or less. That is, the content ratio of the conductive fibers 32 is preferably 35 wt % or more and 80 wt % or less with respect to the entire gas diffusion layer 3. When the content ratio of the conductive fibers 32 is 35 wt % or more, the gaps between the conductive fibers 32 are not excessively reduced, so that water dischargeability and gas diffusibility are improved. When the content ratio of the conductive fibers 32 is 80 wt % or less, the amount of particles filling gaps between the conductive fibers 32 becomes a sufficient amount, so that bulk resistance of the gas diffusion layer 3 is less likely to increase.

The gas diffusion layer 3 preferably contains the polymer resin 33 in an amount of 10 wt % or more and 40 wt % or less. That is, the content ratio of the polymer resin 33 is preferably 10 wt % or more and 40 wt % or less with respect to the entire gas diffusion layer 3. When the content ratio of the polymer resin 33 is 10 wt % or more, the polymer resin 33 sufficiently functions as a binder, and the tensile breaking strength of the gas diffusion layer 3 can be increased. Therefore, even when the pressure of the gas or the swelling and shrinkage of the electrolyte membrane occurs, the gas diffusion layer 3 is less likely to break, and the durability of the fuel cell using the gas diffusion layer 3 is improved. When the content ratio of the polymer resin 33 is 40 wt % or more, the bulk resistance of the gas diffusion layer 3 is less likely to increase, and the battery performance can be improved.

### <Composite Powder 36 for Gas Diffusion Layer>

Next, a composite powder 36 for a gas diffusion layer will be described with reference to FIG. 5. FIG. 5 is a schematic view showing a composite powder for a gas diffusion layer according to the first embodiment.

The composite powder 36 for a gas diffusion layer is a powder before roll pressing for manufacturing the gas diffusion layer 3 of the present disclosure. A detailed manufacturing method will be described later.

As shown in FIG. 5, the composite powder 36 for a gas diffusion layer includes grains, each grain containing conductive particles 31, conductive fibers 32, and a polymer resin 33.

Examples of the shape of the composite powder 36 for a gas diffusion layer include a spherical shape, an elliptical spherical shape, a cylindrical shape, a cubic shape, and a rectangular parallelepiped. In order to improve the fluidity of the powder, a spherical shape or an elliptical spherical shape is preferable.

The average particle diameter D50 of the composite powder 36 for a gas diffusion layer is 30 μm or more and 300 μm or less, more preferably 50 μm or more and 150 μm or less. When the average particle diameter D50 of the composite powder 36 for a gas diffusion layer is less than 30 μm, the average particle diameter D50 of the composite powder 34 inside the gas diffusion layer 3 manufactured by roll pressing is also less than 30 μm. Therefore, as described above, there are many grain boundaries 35 in the gas diffusion layer 3, and when there are many grain boundaries 35, diffusion of gas and water vapor through submicron pores in the composite powder 34 is inhibited by the grain boundaries 35, and the battery performance is deteriorated due to deterioration of gas diffusibility.

On the other hand, when the average particle diameter D50 of the composite powder 36 for a gas diffusion layer is larger than 300 μm, the average particle diameter D50 of the composite powder 34 inside the gas diffusion layer 3 manufactured by roll pressing is similarly larger than 300 μm. Therefore, as described above, in the grain boundaries 35 between the grains included in the composite powder 34 inside the gas diffusion layer 3, the interfaces bonded by the polymer resin decrease and the gaps between the grains included in the composite powder 34 become too large, so that the strength of the gas diffusion layer 3 decreases and the gas diffusion layer 3 cannot exist as a free-standing film.

The average particle diameter of the composite powder 36 for a gas diffusion layer was determined by dispersing the composite powder 36 for a gas diffusion layer in a surfactant, measuring the particle size distribution by a laser diffraction method (MT 3300EXII manufactured by MicrotracBEL Corp.), and calculating a particle diameter D50 corresponding to a cumulative frequency of 50%.

Next, pores inside the composite powder 36 for a gas diffusion layer will be described.

As described above, the gas diffusion layer 3 includes the composite powder 34 containing the conductive particles 31, the conductive fibers 32, and the polymer resin, and grain boundaries between the grains included in the composite powder. Here, the composite powder 34 is a powder obtained by rolling, by roll pressing, the composite powder 36 for a gas diffusion layer and bonding the composite powder 36 for a gas diffusion layer to each other. The composite powder 34 is obtained by applying a pressure and a shearing force when the composite powder 36 for a gas diffusion layer is rolled by roll pressing, and changing the polymer resin into a fibrous form by the shearing force.

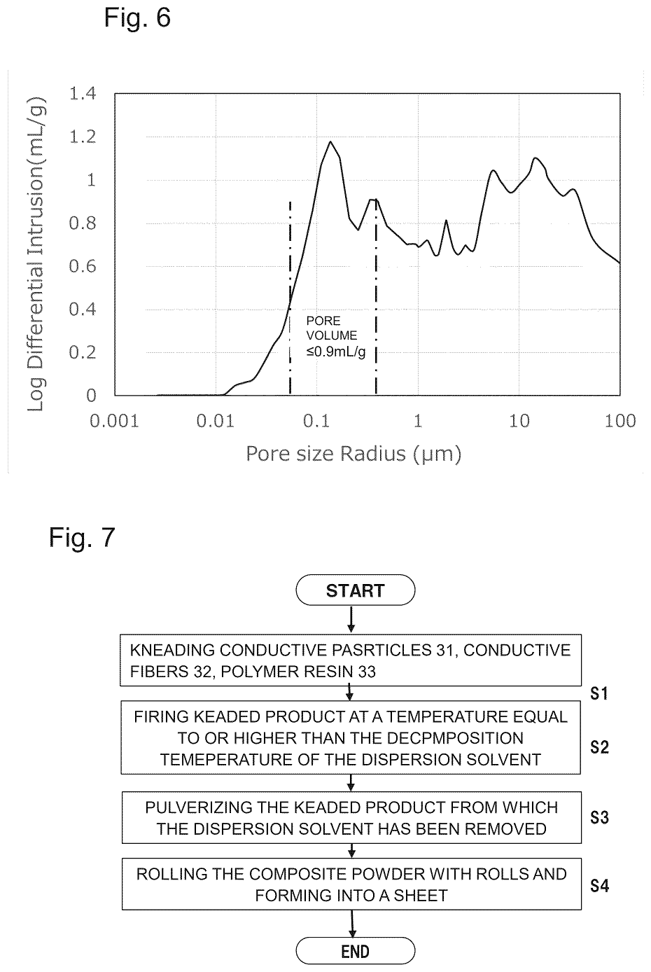

FIG. 6 is a diagram showing a pore distribution of the composite powder for a gas diffusion layer according to the first embodiment.

As shown in FIG. 6, the composite powder 36 for a gas diffusion layer has, inside the powder, pores having a peak in a range of a pore radius of 0.1 μm or more and 0.3 μm or less and pores having a peak in a pore radius of 1 μm or more in a Log differential pore volume graph measured by a mercury intrusion method. It is considered that pores having a peak in the range of a pore radius of 0.1 μm or more and 0.3 μm or less are pores inside the composite powder 36 for a gas diffusion layer, and pores having a peak in the range of a pore radius of 1 μm or more are gaps between the grains included in the composite powder 36 for a gas diffusion layer. When the composite powder 36 for a gas diffusion layer is rolled by roll pressing, the grains included in the composite powder are bound to each other, and the number of pores with a pore radius of 1 μm or more, which is a gap between the composite powder 36 for a gas diffusion layer, is reduced to form the gas diffusion layer 3, which has a pore distribution as shown in FIG. 4.

From the above, as shown in FIG. 6, the composite powder 36 for a gas diffusion layer has pores having a peak in a range of a pore radius of 0.1 μm or more and 0.3 μm or less in a Log differential pore volume graph measured by a mercury intrusion method in the powder. By manufacturing a gas diffusion layer by a manufacturing method described later using the composite powder 36 for a gas diffusion layer, pores having a peak in a range of a pore radius of 0.1 μm or more and 0.3 μm or less can be formed in the gas diffusion layer 3.

In the Log differential pore volume graph measured by the mercury intrusion method in FIG. 6, pores with a pore radius of 1 μm or more can also be confirmed, but it is considered that a gap between the grains included in the composite powder 36 for a gas diffusion layer is detected, and therefore the pore radius is calculated separately from the pores inside the composite powder 36 for a gas diffusion layer.

As shown in FIG. 6, the composite powder 36 for a gas diffusion layer has, inside the powder, pores with a pore radius of 0.055 μm or more and 0.4 μm or less having a pore volume of 0.80 mL/g or less in a Log differential pore volume graph measured by a mercury intrusion method. By manufacturing a gas diffusion layer by a manufacturing method described later using the composite powder 36 for a gas diffusion layer, pores having a pore radius of 0.055 μm or more and 0.4 μm or less and a pore volume of 0.80 mL/g or less can be formed in the gas diffusion layer 3.

### <Method for Manufacturing Gas Diffusion Layer 3>

Next, a method for manufacturing the gas diffusion layer 3 according to the first embodiment of the present disclosure will be described. FIG. 7 is a flowchart showing a method for manufacturing the gas diffusion layer 3 according to the first embodiment. The method for manufacturing the gas diffusion layer 3 of the present disclosure is not limited to the flowchart of FIG. 7 and the manufacturing method described later, and may be changed without departing from the gist of the present disclosure.

In step S1, the conductive particles 31, the conductive fibers 32, and the polymer resin 33 are stirred and kneaded with a dispersion solvent to obtain a kneaded product of the conductive particles 31, the conductive fibers 32, and the polymer resin 33. For the kneading of the material in step S1, for example, a planetary mixer, a hybrid mixer, a kneader, a roll mill, or the like can be used. In step S1, which is a kneading step, the conductive particles 31, the conductive fibers 32, the surfactant, and the dispersion solvent, excluding the polymer resin 33, are first kneaded and dispersed, and then the polymer resin 33 is charged and stirred, whereby the polymer resin 33 can be uniformly dispersed in the kneaded product.

In step S2, the kneaded product is fired at a temperature equal to or higher than the decomposition temperature of the dispersion solvent to remove the dispersion solvent. In the firing in step S2, for example, an IR furnace, a hot air drying furnace, or the like can be used. The firing temperature is set to a temperature higher than the temperature at which the surfactant is decomposed and lower than the temperature at which the polymer resin 33 is melted. The reason is as follows. When the firing temperature is lower than the temperature at which the surfactant is decomposed, the surfactant remains in the gas diffusion layer 3, and the inside of the gas diffusion layer 3 is hydrophilized to retain water, so that the gas permeability of the gas diffusion layer 3 may decrease. On the other hand, when the firing temperature is higher than the melting point of the polymer resin 33, the polymer resin 33 melts, so that the strength of the gas diffusion layer 3 may decrease. Specifically, for example, when PTFE is used as the polymer resin 33, the firing temperature is preferably 280° C. or more and 340° C. or less. The firing time is set according to the firing temperature so that the residue of the dispersion solvent is 1 wt % or less.

In step S3, the kneaded product from which the dispersion solvent has been removed is pulverized to obtain the composite powder 36 for a gas diffusion layer. The pulverization in step S3 is not particularly limited as long as it is an apparatus capable of pulverizing to have an average particle diameter D50 of 30 μm or more and 300 μm or less, and for example, a cutter mill, a jet mill, a pin mill, or the like can be used.

The composite powder 36 for a gas diffusion layer can also be obtained by classifying the powder into particles having an average particle diameter D50 of 30 μm or more and 300 μm or less after pulverization. For classification of the pulverized powder, a vibratory sieve, a rotary sieve, or the like can be used.

In step S4, the composite powder for a gas diffusion layer obtained by the pulverization is rolled with rolls and formed into a sheet to obtain the gas diffusion layer 3. For the roll pressing in step S4, for example, a horizontal roll press machine in which two rolls are arranged in the horizontal direction can be used. The composite powder 36 for a gas diffusion layer prepared in step S3 is supplied between two rolls with a conveyor, an ultrasonic feeder, or the like, and a shearing force is applied to the polymer resin 33 with a roll press force of, for example, 0.01 ton/cm to 4 ton/cm to fibrillate (fiber) the polymer resin 33. By the fibrillated polymer resin 33, the gas diffusion layer 3 having high strength can be obtained. The sheet on which the powder film is formed can be re-rolled by a roll once or a plurality of times to improve the thickness accuracy and the tensile breaking strength of the gas diffusion layer 3.

The surfactant residue of the gas diffusion layer is measured by thermogravimetry. Specifically, TG/DTA6200 (manufactured by Hitachi High-Tech Science Corporation) was used as a measuring apparatus. 10 mg of a sample of the gas diffusion layer was set, and the weight change rate from room temperature to 400° C. was measured at a nitrogen flow rate of 50 ml/min and a temperature rising rate of 10° C./min from room temperature to 400° C.

The present disclosure is not limited to the above embodiment, and can be implemented in various other modes.

### Second Embodiment

### <Method 2 for Manufacturing Gas Diffusion Layer 3>

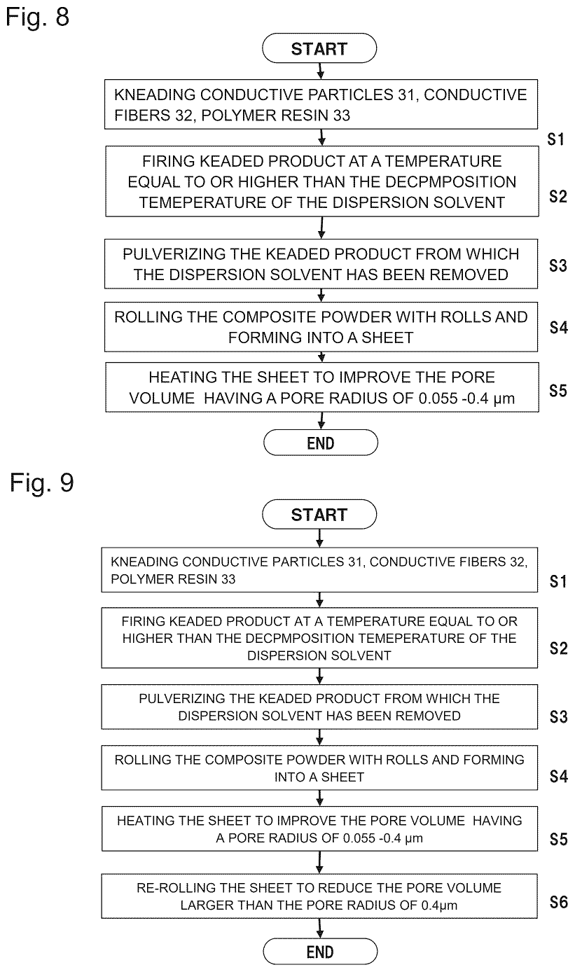

Next, a method for manufacturing the gas diffusion layer 3 according to a second embodiment of the present disclosure will be described. FIG. 8 is a flowchart showing the method for manufacturing the gas diffusion layer 3 according to the second embodiment.

The method for manufacturing the gas diffusion layer according to the second embodiment is different from the method for manufacturing the gas diffusion layer according to the first embodiment in that, as shown in FIG. 8, the manufacturing method in FIG. 7 includes a step of heating a sheet, that is, step S5 after step S4.

In step S5, the polymer resin 33 is softened by heating the sheet prepared in step S4, and the stress of the conductive particles 31 and the conductive fibers 32 compressed by the roll pressing in step S4 is relaxed, so that the pore volume having a pore radius of 0.055 μm or more and 0.4 μm or less can be improved as shown in FIG. 10.

The means for heating the sheet is not particularly limited, but for example, an electric furnace, an IR furnace, or the like can be used.

The heating temperature may be a temperature at which the polymer resin is softened and is not decomposed, and for example, when the polymer resin is PTFE, the polymer resin may be heated to 200 to 390° C. At a temperature lower than 200° C., softening of PTFE is not sufficient, and the pore volume of the gas diffusion layer cannot be improved. On the other hand, when the temperature is 400° C. or higher, PTFE is decomposed, and the strength of the gas diffusion layer decreases.

The heating time may be appropriately adjusted depending on the intended pore volume.

The sheet may be impregnated with a solvent such as ethanol before the heating step. By impregnating the sheet with the solvent, the sheet is softened and easily expanded by heating, and the amount of expansion can be increased by evaporation of the solvent. The solvent is not particularly limited as long as the sheet is impregnated with the solvent.

### Third Embodiment

### <Method 3 for Manufacturing Gas Diffusion Layer 3>

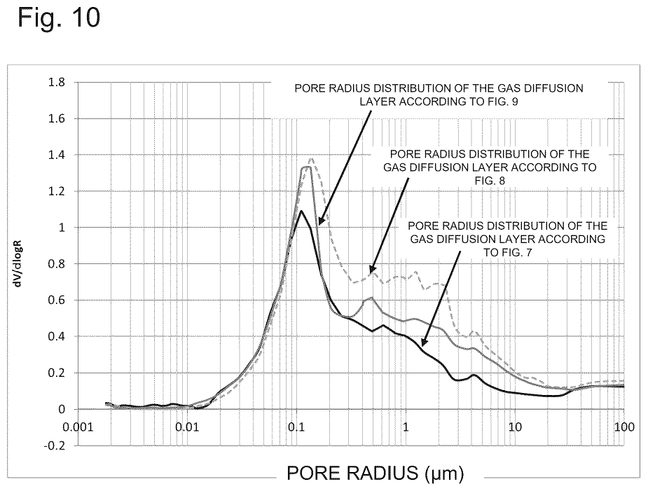

Next, a method for manufacturing the gas diffusion layer 3 according to a third embodiment of the present disclosure will be described. FIG. 9 is a flowchart showing a method for manufacturing the gas diffusion layer 3 according to the third embodiment. FIG. 10 is a diagram showing a pore radius distribution of the composite powder for a gas diffusion layer according to the first, second, third embodiments.

The method for manufacturing the gas diffusion layer according to the third embodiment is different from the method for manufacturing the gas diffusion layer according to the second embodiment in that, as shown in FIG. 9, the manufacturing method in FIG. 8 includes a step of re-rolling a sheet, that is, step S6 after step S5.

In step S6, by re-rolling the sheet prepared in step 5, as shown in FIG. 10, the pore volume larger than the pore radius of 0.4 μm can be reduced, the voids affecting strength can be reduced, and the strength of the gas diffusion layer can be improved.

### <Apparatus for Manufacturing Gas Diffusion Layer 3>

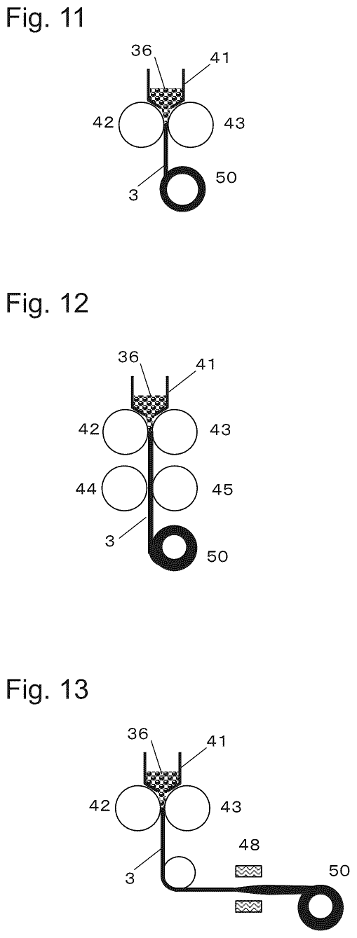

FIG. 11 is a schematic view showing a configuration of the apparatus for manufacturing the gas diffusion layer according to the third embodiment.

As shown in FIG. 11, the apparatus for manufacturing the gas diffusion layer according to the third embodiment includes a pair of a first roll 42 and a second roll 43 for rolling the composite powder, the first roll 42 and the second roll 43 being arranged facing each other, a hopper 41 arranged at an upper portion on an upstream side between the first roll 42 and the second roll 43, and a gas diffusion layer recovery unit 50 arranged at a lower portion on a downstream side of the rolls.

A powder supply unit includes a hopper 41 installed in an upper portion between the first roll 42 and the second roll 43, and a belt conveyor unit (not shown) that supplies powder to the hopper 41. Although not shown, an in-line film thickness measuring device may be installed below the first and second rolls 42 and 43. By controlling the gap and load between the first roll 42 and the second roll 43 based on the measured film thickness, variations in film thickness, porosity, and film strength can be reduced.

The first and second rolls 42 and 43 for rolling the powder may have a constant speed or a circumferential speed difference.

### First Modified Embodiment

FIG. 12 is a schematic view showing a configuration of an apparatus for manufacturing a gas diffusion layer according to a first modified embodiment.

As shown in FIG. 12, the apparatus for manufacturing a gas diffusion layer according to the first modified embodiment includes a first roll 44 and a second roll 45 for adjusting the film thickness and porosity of the sheet 3 under the first and second rolls 42 and 43 for rolling the powder in the manufacturing apparatus of FIG. 11. It is possible to improve the accuracy of the thickness and porosity of the gas diffusion layer 3 by controlling the film thickness and porosity of the sheet formed by the first and second rolls 42 and 43 for rolling the powder, and the gap and load of the first and second rolls 44 and 45.

A powder supply unit includes a hopper 41 installed in an upper portion between the first roll 42 and the second roll 43, and a belt conveyor unit (not shown) that supplies powder to the hopper 41. Although not shown, an in-line film thickness measuring device may be installed below the first and second rolls 42 and 43. By controlling the gap and load between the first roll 42 and the second roll 43 based on the measured film thickness, variations in film thickness, porosity, and film strength can be reduced.

### Second Modified Embodiment

FIG. 13 is a schematic view showing a configuration of an apparatus for manufacturing a gas diffusion layer according to a second modified embodiment.

As shown in FIG. 13, the apparatus for manufacturing a gas diffusion layer according to the second modified embodiment is configured to include an IR furnace 48 as an example of a heating unit installed on the downstream side of the first and second rolls 42 and 43 for rolling a powder and a roll recovery unit 50 as an example of a film recovery unit in the manufacturing apparatus of FIG. 11. Although not shown, in-line film thickness measuring devices may be installed before and after the IR furnace 48. By controlling the temperature of the heating unit, the gap between the first roll 42 and the second roll 43 for rolling the powder, and the load based on the measured film thickness, variations in film thickness, porosity, and film strength can be reduced.

### Third Modified Embodiment

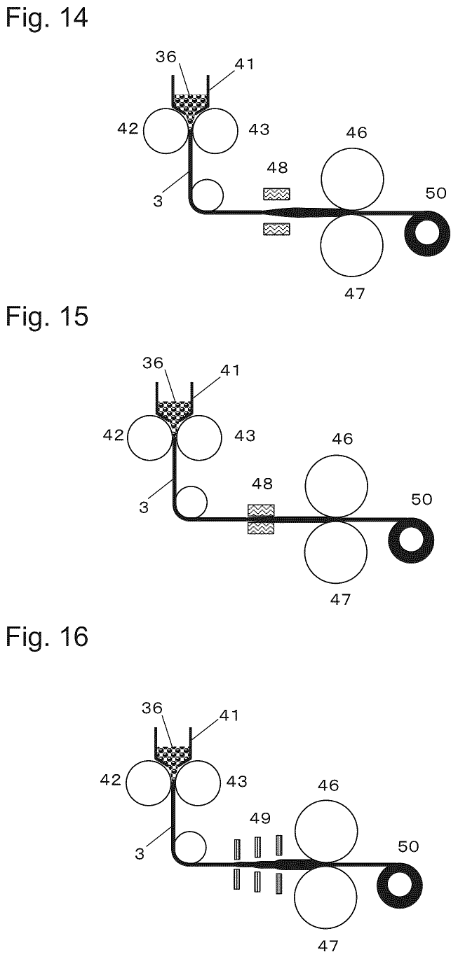

FIG. 14 is a schematic view showing a configuration of an apparatus for manufacturing a gas diffusion layer according to a third modified embodiment.

As shown in FIG. 14, the apparatus for manufacturing a gas diffusion layer according to the third modified embodiment is configured to include first and second rolls 46 and 47 for rolling a pair of heated sheets 3 facing each other installed on the downstream side of the heating unit 48 in the manufacturing apparatus of FIG. 13. By rolling the heated sheets, the film thickness and porosity of the sheet expanded by heating can be adjusted, and the accuracy of the thickness and porosity of the gas diffusion layer 3 can be improved.

The pair of rolls 46 and 47 for rolling the heated sheet rotates in the rolling direction. That is, for example, the first roll 46 is rotated in the left direction and the second roll 47 is rotated in the right direction in the direction in which the highly porous gas diffusion layer enters. The number and diameter of these rolls, the peripheral speed ratio between the first roll 46 and the second roll 47, the loads on the first and second rolls 46 and 47, the inter-roll gap, the roll surface state, and the roll temperature are adjusted by the film quality to be obtained.

As described above, by repeating heating and rolling of the gas diffusion layer once or a plurality of times, a gas diffusion layer having high porosity and high film strength can be obtained.

### Fourth Modified Embodiment

FIG. 15 is a schematic view showing a configuration of an apparatus for manufacturing a gas diffusion layer according to a fourth modified embodiment.

Further, as shown in FIG. 15, a stationary or movable regulating plate or a heated roll heated in the vertical direction of the film by the heating unit may be provided. When the conductive fiber and the polymer resin are heated, the conductive fiber and the polymer resin expand. However, when the conductive fiber and the polymer resin expand too much, the film strength greatly decreases and the film is broken. Therefore, by providing a stationary or movable regulating plate heated in the vertical direction of the film, it is possible to suppress expansion in the film thickness direction or to suppress breakage by applying a load. In the case of a heated roll, shearing can be applied again together with heating, so that rolling after heating can be made unnecessary.

In addition, a stationary or movable regulating plate or roll in which one of the upper and lower surfaces of the film is heated by the heating unit 48 and the other is not heated or cooled may be provided. By heating one surface and not heating or cooling the other surface, a film having a void changed in the film thickness direction can be prepared.

### Fifth Modified Embodiment

FIG. 16 is a schematic view showing a configuration of an apparatus for manufacturing a gas diffusion layer according to a fifth modified embodiment.

As shown in FIG. 16, the heating unit 48 may have a plurality of heating mechanisms that are plasma or flash lamps. As a result, the heating time can be made short and intermittent, a decrease in film strength due to expansion during heating can be reduced, and breakage of the film can be suppressed.

### EXAMPLES

Hereinafter, examples of the present disclosure will be described.

### Materials

The materials used for manufacturing the test pieces of examples and comparative examples are as follows.

### [Conductive Particles 31]

Li-400 (manufactured by Denka Company Limited)

### [Conductive Fibers 32]

VGCF (VGCF-H manufactured by Showa Denko K.K.)

### [Polymer Resin 33]

PTFE dispersion (manufactured by DAIKIN CORPORATION), average particle diameter: 0.25 μm

### (Manufacture of Gas Diffusion Layer of First to Fourth Examples)

A gas diffusion layer of first to fourth examples was manufactured by the following method.

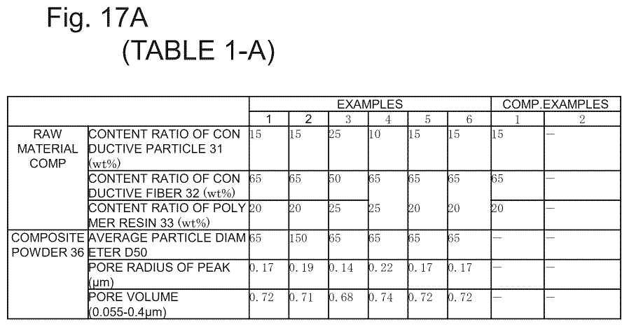

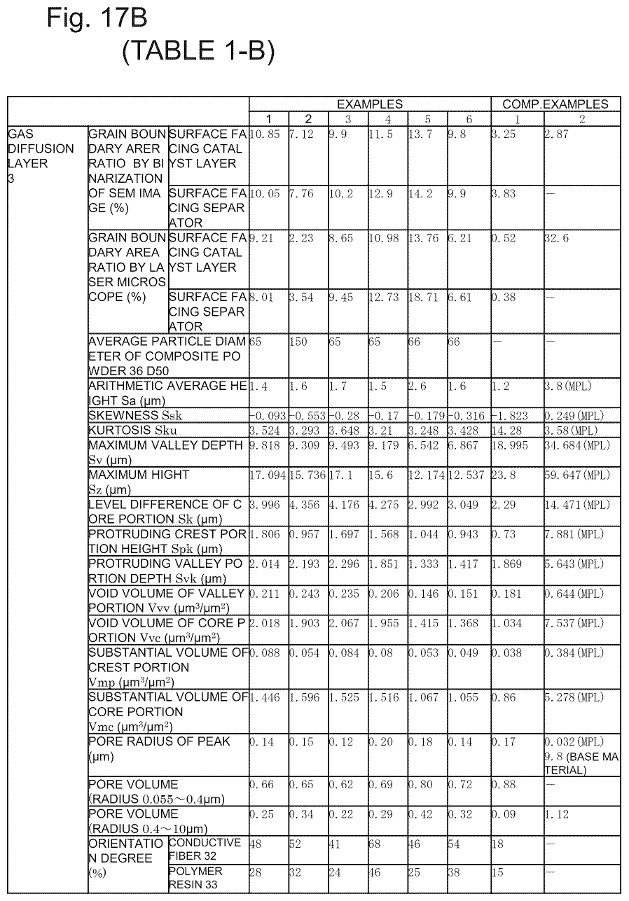

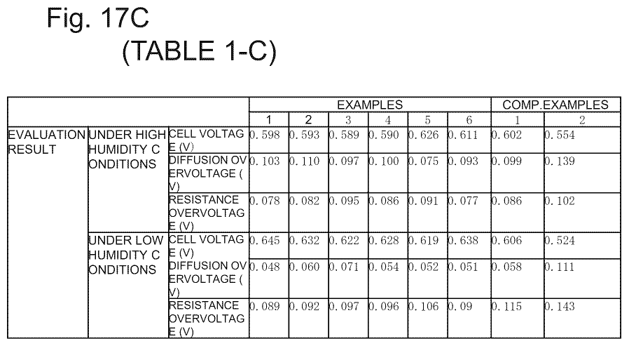

FIGS. 17A, 17B, and 17C are Tables 1-A, 1-B, and 1-C showing the raw material composition, the composite powder for the gas diffusion layer, the characteristics of the gas diffusion layer, and the like in first to sixth examples and first and second comparative examples.

First, conductive particles, conductive fibers, a polymer resin, a surfactant, and a dispersion solvent were blended in ratios shown in the raw material composition column of Table 1-A in FIG. 17A, and kneaded using a planetary mixer. Next, the kneaded mixture was fired at 300° C. for 4 hours in a hot air firing furnace to remove the surfactant and the dispersion solvent. At that time, it was confirmed using TG/DTA that the residue of the surfactant was 1% or less. Thereafter, the fired mixture was pulverized using a cutter mill to prepare a composite powder for a gas diffusion layer of first to fourth examples shown in Table 1-A of FIG. 17A.

Then, the composite powder for a gas diffusion layer was charged into a horizontal roll press and formed into a sheet with a pressing force of 0.2 ton/cm to prepare a gas diffusion layer of first to fourth examples shown in Table 1-A of FIG. 17A. The thickness of each of the gas diffusion layers was 160 μm.

### (Manufacture of Gas Diffusion Layer of Fifth Example)

The gas diffusion layer of fifth example was manufactured by the following method.

First, conductive particles, conductive fibers, a polymer resin, a surfactant, and a dispersion solvent were blended in ratios shown in the raw material column of fifth example in Table 1-A in FIG. 17A, and kneaded using a planetary mixer. Next, the kneaded mixture was fired at 300° C. for 4 hours in a hot air firing furnace to remove the surfactant and the dispersion solvent. At that time, it was confirmed using TG/DTA that the residue of the surfactant was 1% or less. Thereafter, the fired mixture was pulverized using a cutter mill to prepare a composite powder for a gas diffusion layer of fifth example shown in Table 1-A of FIG. 17A.

Subsequently, the composite powder for a gas diffusion layer was charged into a horizontal roll press, and formed into a sheet with a pressing force of 0.2 ton/cm, and then the sheet was heated at 300° C. for 20 minutes to prepare a gas diffusion layer of fifth example shown in Table 1-A of FIG. 17A. The thickness of the gas diffusion layer was 170 μm.

### (Manufacture of Gas Diffusion Layer of Sixth Example)

The gas diffusion layer of sixth example was manufactured by the following method.

First, conductive particles, conductive fibers, a polymer resin, a surfactant, and a dispersion solvent were blended in ratios shown in the raw material column of sixth example in Table 1-A in FIG. 17A, and kneaded using a planetary mixer. Next, the kneaded mixture was fired at 300° C. for 4 hours in a hot air firing furnace to remove the surfactant and the dispersion solvent. At that time, it was confirmed using TG/DTA that the residue of the surfactant was 1% or less. Thereafter, the fired mixture was pulverized using a cutter mill to prepare a composite powder for a gas diffusion layer of sixth example shown in Table 1-A of FIG. 17A.

Subsequently, the composite powder for a gas diffusion layer was charged into a horizontal roll press and formed into a sheet with a pressing force of 0.2 ton/cm. Thereafter, the sheet was heated at 300° C. for 20 minutes, and the heated sheet was charged into a vertical roll press and re-rolled with a pressing force of 0.1 ton/cm to prepare a gas diffusion layer of sixth example shown in Table 1-A of FIG. 17A. The thickness of the gas diffusion layer was 160 μm.

### (Manufacture of Gas Diffusion Layer of First Comparative Example)

The gas diffusion layer of first comparative example was manufactured by the following method.

First, conductive particles, conductive fibers, a polymer resin, a surfactant, and a dispersion solvent were blended in ratios shown in the raw material column in Table 1-A in FIG. 17A, and kneaded using a planetary mixer. Next, the kneaded product was rolled 5 times using a rolling mill under a rolling condition of 0.1 ton/cm. At that time, the rolling direction was rotated by 90° C. every time to gradually reduce the thickness. Thereafter, the rolled sheet was disposed in a hot air firing furnace, and firing was performed at 300° C. for 4 hours. At that time, it was confirmed using TG/DTA that the residue of the surfactant was 1% or less. The fired sheet was re-rolled 3 times using a roll press machine under a rolling condition of 0.5 ton/cm to obtain a gas diffusion layer having a thickness of 160 μm.

### (Gas Diffusion Layer of Second Comparative Example)

As the gas diffusion layer of second comparative example, carbon paper (product number 22BB, thickness 220 μm) manufactured by SGL was used.

### (Manufacture of Single Cell Evaluation Cell)

Catalyst-carrying carbon having platinum particles carried on carbon powder as an electrode catalyst (TEC 10E50E manufactured by Tanaka Kikinzoku Kogyo K.K.: 50 mass % Pt) and a polymer electrolyte solution having hydrogen ion conductivity (Nafion dispersion) were dispersed in a mixed dispersion medium of ethanol and water (mass ratio 1:1) to prepare an ink for forming a cathode catalyst layer. The polymer electrolyte was added so that the mass of the polymer electrolyte in the catalyst layer after coating formation was 0.4 times the mass of the catalyst-carrying carbon.

The obtained ink for forming a cathode catalyst layer was applied to one surface of a polymer electrolyte membrane (GSII manufactured by Japan Gore-Tex Corporation, 120 mm×120 mm) by a spray method to form a cathode catalyst layer so that the platinum carrying amount was 0.3 mg/cm².

Next, similarly to the cathode electrode, an anode catalyst layer was formed so that the platinum carrying amount was 0.1 mg/cm².

As the anode-side gas diffusion layer, carbon paper manufactured by SGL was used.

The gas diffusion layers of first to fourth examples and first and second comparative examples were joined to a cathode catalyst layer as a cathode-side gas diffusion layer. The anode-side gas diffusion layer was bonded to the anode catalyst layer. Thus, the MEA was obtained.

Next, a fuel cell, which was a test piece, was manufactured using the separator in which the flow path was formed. First, the manufactured MEA was sandwiched between an anode side separator having a fluid flow path for supplying a fuel gas and a cooling water flow path and a cathode side separator having a gas flow path for supplying an oxidant gas, and a fluororubber gasket was disposed around the cathode and the anode to manufacture a unit cell. The effective electrode (anode or cathode) area is 36 cm². This unit cell was used as a test piece. (Evaluation Test)

The following evaluation tests were performed for first to sixth examples and first and second comparative examples. The evaluation results are shown in Table 1-A of FIG. 17A.

### [Cell Voltage]

The cell voltage was measured under the following conditions. The cell temperature of the unit cell of the test piece was controlled to 75° C., hydrogen gas was supplied as fuel gas to the gas flow path on the anode side, and air was supplied to the gas flow path on the cathode side. The stoichiometry of hydrogen gas was 1.5, and the stoichiometry of air was 1.8. The fuel gas and the air were humidified so that the dew point was 75° C. during power generation under high humidity conditions and the dew point was 45° C. during power generation under low humidity conditions, and then supplied to the unit cell. A cell voltage at a current density of 2.0 A/cm² was measured while a current density was held at every 0.5 A/cm² for 3 minutes from 0 A/cm² to 2.0 A/cm².

### [Diffusion Overvoltage]

The diffusion overvoltage was measured when the current density was 2.0 A/cm² under the same conditions as in the measurement of the cell voltage.

### [Resistance Overvoltage]

The resistance overvoltage was measured when the current density was 2.0 A/cm² under the same conditions as in the measurement of the cell voltage.

As shown in Tables 1-B of FIG. 17B and 1-C of FIG. 17C, in the gas diffusion layer 3 of first to sixth examples, composite powder 36 for a gas diffusion layer having an average particle diameter D50 of 30 to 300 μm, a peak of a pore radius in pores in the powder of 0.1 to 0.3 μm, and a pore volume of 0.80 mL/g or less with a pore radius of 0.055 to 0.4 μm was used. The composite powder 36 for a gas diffusion layer was rolled by roll pressing to obtain a gas diffusion layer. In the obtained gas diffusion layer, the grain boundary area ratio calculated by binarizing the X-ray CT image is 5% or more, the grain boundary area ratio calculated by a laser microscope is 1% or more and 30% or less, the average particle diameter D50 of the composite powder 34 is 30 to 300 μm, the arithmetic average height Sa of the surface is 3 μm or less, the skewness Ssk of the surface is a negative value, the kurtosis Sku of the surface is 5 or less, the maximum valley depth Sv of the surface is 15 μm or less, the maximum height Sz of the surface is 40 μm or less, the level difference Sk of the core portion is 13 μm or less, the protruding crest portion height Spk is 5 μm or less, and the protruding valley portion depth Svk is 4 μm or less, which are calculated using the load curve of the surface, and the void volume Vvv of the valley portion is 0.5 μm³/μm² or less, the void volume Vvc of the core portion is 7 μm³/μm² or less, the actual volume Vmp of the crest portion is 0.3 μm³/μm² or less, the actual volume Vmc of the core portion is 5.0 μm³/μm² or less, the peak of the pore radius is 0.1 to 0.3 μm, the pore volume of the pore radius of 0.055 to 0.4 μm is 0.80 mL/g or less, the orientation degree of the conductive particles is 30 to 70%, and the orientation degree of the polymer resin is 5 to 70%, which are calculated using the load curve of the surface.

Therefore, as compared with first comparative example, it was confirmed that in first to sixth examples, while the cell voltage during power generation under low humidity conditions was improved, substantially the same cell voltage was maintained during power generation under high humidity conditions.

The gas diffusion layer used in second comparative example is a gas diffusion layer in which MPL is applied to a substrate. Carbon particles and particles containing a polymer resin as a main component were applied to the MPL surface, but die coating or spray coating was performed in a state of being dispersed in a solvent, so that a clear grain boundary could not be confirmed. In addition, the arithmetic average height Sa of the MPL surface was 3.8 μm, and two peaks of the pore radius were 0.032 μm and 9.8 μm. The peak of the pore radius of 0.032 μm is in a pore in a gap between carbon particles of MPL, and the pore with the pore radius of 9.8 μm is in a pore in a gap between long carbon fibers of the base material.

In second comparative example, the cell voltage is lower in both the high humidity conditions and the low humidity conditions than in first to sixth examples. In the gas diffusion layer of second comparative example, it is considered that condensed water stagnates in pores of the base material during power generation under high humidity conditions, and gas diffusibility is deteriorated. On the other hand, during power generation under low humidity conditions, it is considered that since the MPL is thin, water generated by power generation is discharged from the MPL to the outside through the base material, the water retainability inside the MEA is lowered, and the proton resistance is increased.

The gas diffusion layer according to the present disclosure is particularly useful as a member used for a fuel cell, and can be applied to applications such as a household cogeneration system, an automobile fuel cell, a mobile fuel cell, and a backup fuel cell.

### REFERENCE SIGNS LIST

100 fuel cell
1 polymer electrolyte membrane
2 catalyst layer
2a anode catalyst layer
2b cathode catalyst layer
3 gas diffusion layer
3a anode-side gas diffusion layer
3b cathode gas diffusion layer
4 separator
4a anode side separator
4b cathode side separator
5 fluid flow path
6 rib portion
10 battery cell
11 current collecting plate
12 insulating plate
13 end plate
20 membrane electrode assembly
31 conductive particle
32 conductive fiber
33 polymer resin
34 composite powder
35 grain boundary
36 composite powder for gas diffusion layer
41 hopper
42 first roll
43 second roll
44 first roll
45 second roll
46 first roll
47 second roll
48 heating unit
49 plasma or flash lamp
50 gas diffusion layer recovery unit

What is claimed is:

1. A gas diffusion layer composed of a sheet of composite powder, the composite powder containing:
conductive particles;
conductive fibers; and
a polymer resin,
wherein a grain boundary of the composite powder is present on a surface or a cross section of the gas diffusion layer.

2. The gas diffusion layer according to claim 1, wherein, in a surface or a cross section of the gas diffusion layer, an area of a grain boundary of the composite powder included in the surface or the cross section is calculated by binarizing an SEM image, and the area of the grain boundary of the composite powder is 5% or more with respect to an area of the surface or the cross section in the SEM image.

3. The gas diffusion layer according to claim 1, wherein
a maximum height Sz is calculated from a 3D image in a surface or a cross section of the gas diffusion layer, and an area of a grain boundary of the composite powder included in the surface or the cross section is defined as an area from a lowest point of the 3D image to a height that is 40% of Sz, and the area of the grain boundary of the composite powder is 1% or more and 30% or less with respect to an area of the surface or the cross section in the 3D image.

4. The gas diffusion layer according to claim 1, wherein the composite powder has a particle diameter D50 of 30 μm or more and 300 μm or less.

5. The gas diffusion layer according to claim 1, wherein an arithmetic average height Sa of a surface of the gas diffusion layer is 3 μm or less.

6. The gas diffusion layer according to claim 1, wherein a skewness Ssk of a surface of the gas diffusion layer is a negative value, and kurtosis Sku of the surface is 5 or less.

7. The gas diffusion layer according to claim 1, wherein a maximum valley depth Sv of a surface of the gas diffusion layer is 15 μm or less, and a maximum height Sz of the surface is 40 μm or less.

8. The gas diffusion layer according to claim 1, wherein a level difference Sk of a core portion is 13 μm or less, a protruding crest portion height Spk is 5 μm or less, and a protruding valley portion depth Svk is 4 μm or less, the level difference Sk, the protruding crest portion height Spk, and the protruding valley portion depth Svk being calculated using a load curve of a surface of the gas diffusion layer.

9. The gas diffusion layer according to claim 1, wherein a void volume Vvv of a valley portion is 0.5 μm³/μm² or less, a void volume Vvc of a core portion is 7 μm³/μm² or less, a substantial volume Vmp of a crest portion is 0.3 μm³/μm² or less, and a substantial volume Vmc of the core portion is 5.0 μm³/μm² or less, the void volume Vvv, the void volume Vvc, the substantial volume Vmp, and the substantial volume Vmc being calculated using a load curve of a surface of the gas diffusion layer.

10. The gas diffusion layer according to claim 1, wherein the gas diffusion layer has, inside the sheet of the gas diffusion layer,
pores having a peak in a range of a pore radius of 0.1 μm or more and 0.3 μm or less and
a pore volume of pores with a pore radius of 0.055 μm or more and 0.4 μm or less of 0.80 mL/g or less in a Log differential pore volume distribution graph measured by a mercury intrusion method.

11. The gas diffusion layer according to claim 1, wherein the gas diffusion layer has, inside the sheet of the gas diffusion layer, pores having a peak in a range of a pore radius of 0.1 μm or more and 0.3 μm or less, a pore volume of pores with a pore radius of 0.055 μm or more and 0.4 μm or less being 0.80 mL/g or less, and a pore volume of pores with a pore radius of 0.4 μm or more and 10 μm or less being 0.10 mL/g or more, in a Log differential pore volume graph measured by a mercury intrusion method.

12. The gas diffusion layer according to claim 1, wherein an orientation degree of the conductive fibers is 30% or more and 70% or less, and an orientation degree of the polymer resin is 5% or more and 70% or less in orientation evaluation by fine portion X-ray diffraction measurement.

13. A membrane electrode assembly comprising:
the gas diffusion layer according to claim 1;
a pair of electrodes; and
an electrolyte membrane.

14. A fuel cell comprising:
the membrane electrode assembly according to claim 13; and
a current collecting plate.

15. A composite powder for a gas diffusion layer, comprising:
conductive particles;
conductive fibers; and
a polymer resin,
wherein an average particle diameter D50 of the composite powder is 30 μm or more and 300 μm or less, and
in the composite powder, pores having a peak in a range of a pore radius of 0.1 μm or more and 0.3 μm or less are present in a Log differential pore volume graph measured by a mercury intrusion method,
wherein the composite powder for a gas diffusion layer has, inside the composite powder for a gas diffusion layer, pores with a pore radius of 0.055 μm or more and 0.4 μm or less having a pore volume of 0.90 mL/g or less in a Log differential pore volume graph measured by a mercury intrusion method.

16. A method for manufacturing a gas diffusion layer, the method comprising:
stirring and kneading conductive particles, conductive fibers, and a polymer resin with a dispersion solvent to obtain a kneaded product of the conductive particles, the conductive fibers, and the polymer resin;
firing the kneaded product at a temperature equal to or higher than a decomposition temperature of the dispersion solvent to remove the dispersion solvent to obtain a solid;
pulverizing the solid to obtain a composite powder containing the conductive particles, the conductive fibers, and the polymer resin; and
rolling the composite powder with a roll to form a sheet to obtain a gas diffusion layer containing a sheet.

17. The method for manufacturing a gas diffusion layer according to claim 16, wherein in the course of pulverizing the solid, the solid is pulverized into a composite powder having an average particle diameter D50 of 30 μm or more and 300 μm or less.

18. The method for manufacturing a gas diffusion layer according to claim 16, further comprising heating the sheet after rolling the composite powder with a roll to form a sheet.

19. The method for manufacturing a gas diffusion layer according to claim 16, further comprising heating one surface of the sheet while cooling the other surface after rolling the composite powder with a roll to form a sheet.

20. The method for manufacturing a gas diffusion layer according to claim 16, further comprising re-rolling a sheet between a pair of rolls after rolling the composite powder with rolls to form the sheet.
